(19) United States
(12) Patent Application Publication
(10) Pub. No.: US 2022/0336808 A1
(43) Pub. Date: Oct. 20, 2022

(54) ELECTRODE MATERIAL AND PREPARATION METHOD THEREOF

(71) Applicants: Yunnan Huapu Quantum Material Co., Ltd, Kunming (CN); Chongqing Institute of East China Normal University, Chongqing (CN); ROI Optoelectronics Technology CO, LTD., Shanghai (CN); East China Normal University, Shanghai (CN)

(72) Inventors: Heping Zeng, Chongqing (CN); Mengyun Hu, Chongqing (CN)

(21) Appl. No.: 17/724,569

(22) Filed: Apr. 20, 2022

(30) Foreign Application Priority Data
Apr. 20, 2021 (CN) 202110423375.9

(51) Int. Cl. H01M 4/583; H01M 4/36; H01M 4/62; H01M 4/80; H01M 4/48; H01M 4/04

(52) U.S. Cl. CPC H01M 4/583; H01M 4/364; H01M 4/366; H01M 4/622; H01M 4/806; H01M 4/48; H01M 4/0404; H01M 2004/021

(57) ABSTRACT

The present disclosure provides an electrode material and a method for preparing the same. The electrode material includes 3 to 7 wt % of a graphene material, 4 to 8 wt % of a photocatalytic nano-material, 3 to 9 wt % of a binder system, and a balance of a glass fiber cloth, based on a total weight of the electrode material. The method includes providing a graphene-based precursor solution;

agitating and dispersing a glass fiber cloth to obtain an uniform slurry; wet forming the slurry to obtain a glass fiber sheet, and cleaning and drying the glass fiber sheet; putting the glass fiber sheet into the graphene-based precursor solution for in-situ synthesis to obtain a glass fiber paper; and immersing the glass fiber paper with a binder system and drying the glass fiber paper to obtain the electrode material.

### CROSS-REFERENCE TO RELATED APPLICATION

This application claims priority to Chinese Patent Application No. 202110423375.9, filed on Apr. 20, 2021, the entire disclosure of which is incorporated herein by reference.

### FIELD

The present disclosure relates to the technical field of composite functional materials, and more particularly to an electrode material and a preparation method thereof.

### BACKGROUND

Capacitive deionization (CDI) is an emerging desalination technology in recent years, which has attracted more and more attention as it may be performed by a simple device at a normal temperature and a normal pressure with low costs and has ion selectivity. However, the common CDI technology has insufficient cycle stability and low charge efficiency, which hinder further development and commercialization of CDI. In recent years, graphene has been used as an electrode material for CDI and has attracted extensive attention. Graphene has high electrical conductivity, which reduces addition of conductive additives. In addition, the graphene has a two-dimensional layered carbon structure, such that the graphene has a high specific surface area, which provides a large number of adsorption sites for ions and is beneficial to improve removal rate of ions. At present, most of the CDI electrode materials are generally prepared by formulating a slurry of a graphene-based material, a binder and a conductive agent, and coating the slurry, which has a relatively complicated process and high cost, and is not conducive to commercial production of irregular and large-area electrode materials.

### SUMMARY

Embodiments of the present disclosure seek to solve at least one of the problems existing in the related art to at least some extent.

An object of the present disclosure is to provide a method for preparing an electrode material, in which graphene and photocatalytic nanoparticles are in-situ growth on and organically combined with glass fibers. The electrode material obtained thereby can be cut, has high removal rate of harmful ions, and is renewable by a photocatalytic technology.

In a first aspect of the present disclosure, an electrode material is provided, which includes:

3 to 7 wt % of a graphene material;

4 to 8 wt % of a photocatalytic nano-material;

3 to 9 wt % of a binder system; and

a balance of a glass fiber cloth,

based on a total weight of the electrode material.

In some embodiments of the present disclosure, the glass fiber cloth includes: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth.

In some embodiments of the present disclosure, the glass fiber cloth includes: 56.5 to 65.5 wt % of SiO₂, 2.5 to 7.5 wt % of Al₂O₃, 4.5 to 8.5 wt % of MgO, 1.5 to 4.5 wt % of CaO, 3 to 6.5 wt % of B₂O₃, 4.5 to 7.5 wt % of a mixture of Fe₂O₃, ZnO and BaO, and 8 to 10.5 wt % of an alkali metal oxide R₂O, based on a total weight of the glass fiber cloth.

In some embodiments of the present disclosure, the alkali metal oxide is at least one selected from Na₂O and K₂O.

In some embodiments of the present disclosure, glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

In some embodiments of the present disclosure, the electrode material includes:

a main body of the glass fiber cloth;

a composite material layer of graphene and a photocatalytic nano-material grown in-situ on a surface of the glass fiber cloth; and

a nano-binder layer formed on the composite material layer.

In some embodiments of the present disclosure, the glass fiber cloth has a three-dimensional porous network structure where glass fibers with different diameters are overlapped with each other.

In some embodiments of the present disclosure, the binder system includes one or more binders at different weight ratios.

In some embodiments of the present disclosure, the binder system includes at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.

In some embodiments of the present disclosure, the photocatalytic nano-material includes at least one photocatalytic renewable nano-material selected from zinc oxide, titanium oxide and tungsten oxide.

In some embodiments of the present disclosure, a composite material of graphene and the photocatalytic nano-material is closely and uniformly distributed on the glass fiber cloth.

In a second aspect of the present disclosure, a method for preparing an electrode material is provided, which includes:

providing a graphene-based precursor solution with a concentration of 6 to 8 mg/L by dissolving a carbon source and a photocatalytic nano-material in water;

agitating and dispersing two or more glass fiber cloths with different diameters to obtain an uniform slurry;

wet forming the slurry to obtain a glass fiber sheet, and cleaning and drying the glass fiber sheet;

putting the glass fiber sheet into the graphene-based precursor solution for in-situ synthesis such that the carbon source is in-situ grown into a graphene-based material on glass fibers to obtain a glass fiber paper; and

immersing the glass fiber paper with a binder system and drying the glass fiber paper to obtain the electrode material.

In some embodiments of the present disclosure, the carbon source includes at least one selected from glucose, a biomass and graphite oxide.

In some embodiments of the present disclosure, the photocatalytic nano-material includes at least one selected from zinc oxide, titanium oxide and tungsten oxide.

In some embodiments of the present disclosure, the agitating and dispersing are performed at an agitating speed of 5000 to 12000 rpm, and the slurry has a concentration of 5 to 10 wt % and a pH value of 3.0 to 5.0.

In some embodiments of the present disclosure, the cleaning is performed in a hydrochloric acid solution with a concentration of 3 to 6 mol/L for 30 to 60 min.

In some embodiments of the present disclosure, the drying the glass fiber sheet includes drying the glass fiber sheet on a drying plate at a temperature of 100 to 115° C. for 4 to 6 min.

In some embodiments of the present disclosure, the in-situ synthesis is performed by H₂ reduction, high temperature graphene oxide reduction, microwave heating or laser reduction.

In some embodiments of the present disclosure, the drying the glass fiber paper includes drying the glass fiber paper at a temperature of 100 to 200° C. for 6 to 10 min.

In some embodiments of the present disclosure, the glass fiber cloth includes: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth.

The alkali metal oxide is at least one selected from Na₂O and K₂O.

Glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

In some embodiments of the present disclosure, the binder system includes at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.

### BRIEF DESCRIPTION OF THE DRAWINGS

FIG. 1 is a schematic diagram showing an electrode material and its chemical bonding according to some embodiments of the present disclosure.

FIG. 2 is a schematic diagram showing a working principle of an electrode material according to some embodiments of the present disclosure.

FIG. 3 is a schematic diagram showing a photocatalytic principle of an electrode material according to some embodiments of the present disclosure.

FIG. 4 is a schematic diagram showing a filtering application of an electrode material according to some embodiments of the present disclosure.

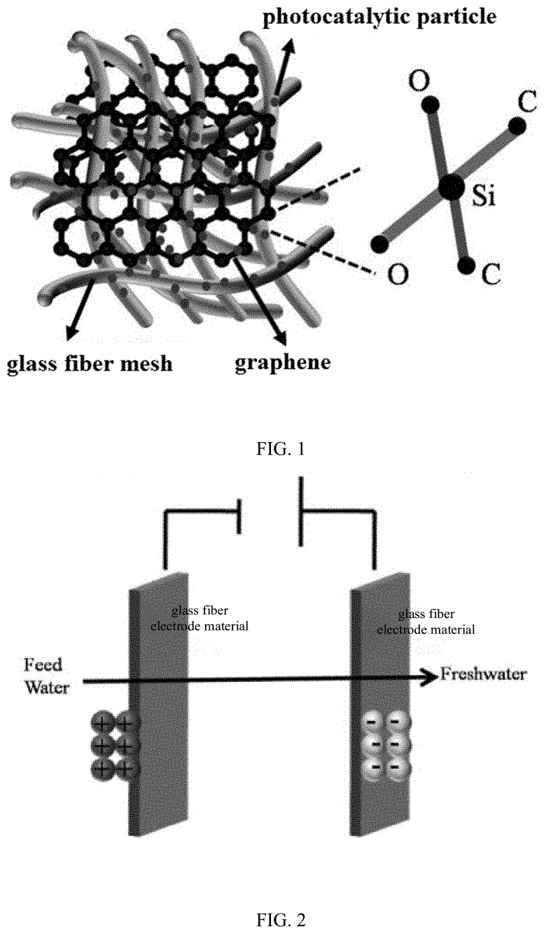

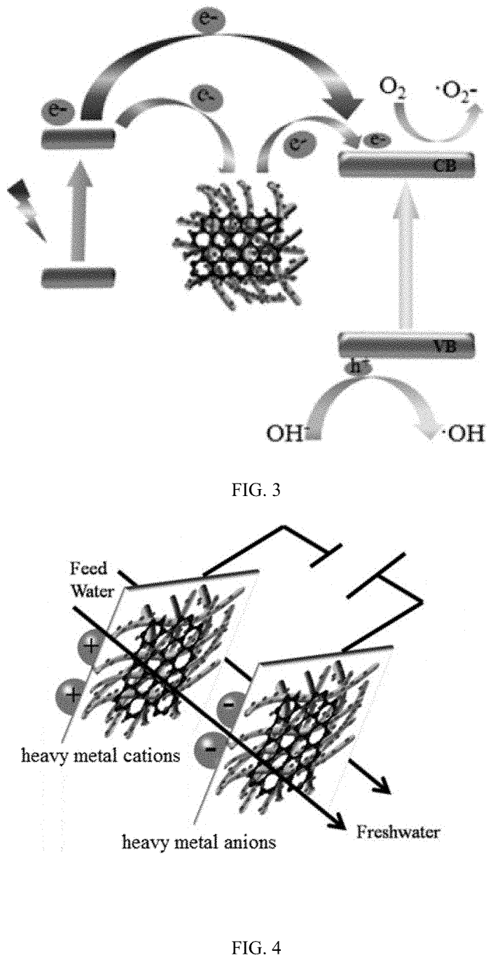

### DETAILED DESCRIPTION

Embodiments of the present disclosure are described in detail below, examples of which are illustrated in the drawings. The embodiments and examples described herein are illustrative and shall not be construed to limit the present disclosure.

The performance of capacitive deionization (CDI) electrode materials is generally related to porosity, electrical conductivity, hydrophilicity and electrochemical stability. In order to obtain an electrode material with an excellent CDI performance, various factors should be considered. The inventors found that a CDI electrode material with excellent CDI performance may be obtained by in-suit growth of graphene-photocatalytic nanoparticle composite on glass fibers. The CDI electrode material combines the hydrophilicity and filtration properties of the glass fibers, the excellent electrical conductivity of the graphene-based materials as well as desorption and regeneration properties of the green photocatalytic nano-materials, and the CDI electrode material may be recycled and may be produced in a large scale.

The present disclosure provides an electrode material. The electrode material includes: 3 to 7 wt % of a graphene material, 4 to 8 wt % of a photocatalytic nano-material, 3 to 9 wt % of a binder system, and a balance of a glass fiber cloth, based on a total weight of the electrode material.

Furthermore, the glass fiber cloth may be an ultrafine glass fiber cloth.

In some embodiments of the present disclosure, the glass fiber cloth includes: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth.

In some embodiments of the present disclosure, the alkali metal oxide is at least one selected from Na₂O and K₂O.

In some embodiments of the present disclosure, glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

In some embodiments of the present disclosure, the glass fiber cloth constitutes a main body of the electrode material, and a composite material layer of graphene and a photocatalytic nano-material is grown in-situ on surfaces of the glass fibers, and a nano-binder layer is formed on the surfaces of the glass fibers.

In some embodiments of the present disclosure, the glass fiber cloth has a three-dimensional porous network structure where glass fibers with different diameters are overlapped with each other.

In some embodiments of the present disclosure, the binder system includes one or more binders at different weight ratios.

In some embodiments of the present disclosure, the binder system includes at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.

In some embodiments of the present disclosure, the photocatalytic nano-material includes at least one photocatalytic renewable material selected from zinc oxide, titanium oxide and tungsten oxide. Furthermore, the photocatalytic nano-material may be regenerated by a photocatalytic reaction.

In some embodiments of the present disclosure, a composite material of the graphene and the photocatalytic nano-material is closely and uniformly distributed on the glass fiber cloth.

In the electrode material according to embodiments of the present disclosure, the composite material of the graphene and the photocatalytic nano-material is grown in-situ on the surfaces of the glass fibers of the glass fiber cloth, such that the composite material is chemically bonded with the glass fibers.

In addition, the graphene is loaded on the three-dimensional porous structure of the glass fiber cloth, such that the electrode materials may electro-absorb and remove harmful ions to filtrate water at a low voltage.

The present disclosure provides a method for preparing an electrode material. The method includes:

providing a graphene-based precursor solution with a concentration of 6 to 8 mg/L by dissolving a carbon source and a photocatalytic nano-material in water;

agitating and dispersing two or more glass fiber cloths with different diameters to obtain an uniform slurry;

wet forming the slurry to obtain a glass fiber sheet, and cleaning and drying the glass fiber sheet;

putting the glass fiber sheet into the graphene-based precursor solution for in-situ synthesis such that the carbon source is in-situ grown into a graphene-based material on glass fibers to obtain a glass fiber paper; and

immersing the glass fiber paper with a binder system and drying the glass fiber paper to obtain the electrode material.

Furthermore, the agitating and dispersing may be performed by a fiber dissociation device.

In some embodiments of the present disclosure, the carbon source includes at least one selected from glucose, a biomass and graphite oxide.

In some embodiments of the present disclosure, the photocatalytic nano-material includes at least one selected from zinc oxide, titanium oxide and tungsten oxide.

In some embodiments of the present disclosure, the agitating and dispersing are performed at an agitating speed of 5000 to 12000 rpm, and the slurry has a concentration of 5 to 10 wt % and a pH value of 3.0 to 5.0.

In some embodiments of the present disclosure, the cleaning is performed in a hydrochloric acid solution with a concentration of 3 to 6 mol/L for 30 to 60 min. By acid cleaning the glass fiber sheet, the surface of the glass fibers is hydroxylated, and the silicon-oxygen bond is broken, which provide bonding sites for graphene and the glass fibers, thereby improving adhesion stability between graphene and the glass fibers.

In some embodiments of the present disclosure, the drying the glass fiber sheet includes drying the glass fiber sheet on a drying plate at a temperature of 100 to 115° C. for 4 to 6 min.

In some embodiments of the present disclosure, the in-situ synthesis is performed by H2 reduction, high temperature graphene oxide reduction, microwave heating or laser reduction.

In some embodiments of the present disclosure, the drying the glass fiber paper includes drying the glass fiber paper at a temperature of 100 to 200° C. for 6 to 10 min.

In some embodiments of the present disclosure, the glass fiber cloth includes: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth.

In some embodiments of the present disclosure, the alkali metal oxide is at least one selected from Na₂O and K₂O.

In some embodiments of the present disclosure, glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

In some embodiments of the present disclosure, the binder system includes at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.

In the present disclosure, the glass fiber cloth is loaded with a certain amount of graphene material, which ensures that the glass fibers are connected by the graphene material, and the electrode material finally obtained has conductivity.

Furthermore, the glass fiber cloth adsorbs a certain amount of photocatalytic nano-material by chemical bonding, such that the electrode material finally obtained may be regenerated by desorption under light illumination, and thus the electrode material may be recycled.

The electrode material of the present disclosure may be prepared into different sizes as required. In addition, the electrode material may be applied with a voltage of 1.0 to 100.0 V, such that the electrode material may absorb harmful ions efficiently under a low voltage. The voltage may be applied by connecting the electrode material to a power supply through a conductive material such as a conductive tape or an iron mesh.

In some embodiments of the present disclosure, the electrode material may be used as double electric layers of a supercapacitor, in which the formation of a voltage field causes positive and negative ions in the solution to move directionally. Besides, in combination with the good hydrophilicity and filtration capacity of the glass fibers, the harmful ions in the solution may be electro-absorbed and removed efficiently.

Embodiments of the present disclosure have the following advantageous technical effects.

The method provided in the present disclosure includes the acid cleaning operation, by which a concentration of hydroxyl groups on the surfaces of the glass fibers is increased, and the silicon-oxygen bond of the glass fibers is broken at the same time, which provides bonding sites for interface connection between graphene or the photocatalytic nano-material and the glass fibers, such that graphene and the photocatalytic nano-material are chemically bonded with the glass fibers, thereby greatly increasing the adhesion stability and binding forces of the graphene or the photocatalytic nano-material with the glass fibers.

In the method for preparing the electrode material according to the present disclosure, the composite of the graphene and the photocatalytic nano-material is in-situ synthesized on the glass fibers, which reduces the addition of conductive agents as compared with a traditional coating method, and the electrode material may be prepared in a large area. In addition, the electrode material of the present disclosure makes full use of the hydrophilicity of the glass fiber to meet the actual use conditions of the CDI electrode material.

The in-situ growth of the graphene material on the surfaces of the glass fibers provides the finally obtained electrode material with excellent electro-adsorption performance due to the good electrical conductivity of the graphene material. Further, due to desorption and regeneration performances of the photocatalytic nano-materials, the introduction of the photocatalytic nanoparticles that can be produced in large-scale makes the finally obtained electrode material can be recycled.

### Example 1

4 g of glucose and 2 g of zinc oxide nanoparticles were ultrasonically dissolved in 50 ml of deionized water for 30 min to obtain a graphene-based precursor solution. 40 parts of glass fiber cloth with a diameter of 3.0 μm and 10 parts of glass fiber cloth with a diameter of 1.0 μm were agitated and dispersed by a fiber dissociation device at 6000 r/min for 3 min to obtain a slurry with a concentration of 6 wt %. The slurry was wet formed by a paper machine to obtain a glass fiber sheet. The glass fiber sheet was cleaned in 50 ml of hydrochloric acid solution with a concentration of 3 mol/L for 30 min, and dried on a drying plate at a temperature of 100° C. for 5 min. The dried glass fiber sheet was put into the graphene-based precursor solution and reacted in a microwave rapid reactor at 100° C. for 6 min, so as to in-situ synthesize a composite material of graphene and photocatalytic nano-material. The obtained material was then immersed in a binder system containing a polyurethane-modified phenolic resin in such a way that the amount of the binder system contained in the finally obtained electrode material is 3 wt % based on the total weight of the finally obtained electrode material, and then was dried in a blast drying oven at 100° C. for 6 min to obtain a CDI electrode material. The electrode material was cut into 3×3 cm. The electrode material achieved 100% removal rate on mixed harmful ions including 0.2 mg/L of Ag(I), 0.2 mg/L of Cu(II), 0.2 mg/L of Pb(II), 0.2 mg/L of Se (IV, SeO₃²⁻) and 0.2 mg/L of Sb(III) under application of 1.0 V DC voltage for 30 min.

### Example 2

6 g of glucose and 2 g of zinc oxide nanoparticles were ultrasonically dissolved in 50 ml of deionized water for 30 min to obtain a graphene-based precursor solution. 40 parts of glass fiber cloth with a diameter of 3.5 μm and 10 parts of glass fiber cloth with a diameter of 1.5 μm were agitated and dispersed by a fiber dissociation device at 7000 r/min for 4 min to obtain a slurry with a concentration of 7 wt %. The slurry was wet formed by a paper machine to obtain a glass fiber sheet. The glass fiber sheet was cleaned in 50 ml of hydrochloric acid solution with a concentration of 4.5 mol/L for 45 min, and dried on a drying plate at a temperature of 100° C. for 5 min. The dried glass fiber sheet was put into the graphene-based precursor solution and reacted in a microwave rapid reactor at 150° C. for 8 min, so as to in-situ synthesize a composite material of graphene and photocatalytic nano-material. The obtained material was then immersed in a binder system containing a polyurethane-modified phenolic resin in such a way that the amount of the binder system contained in the finally obtained electrode material is 6 wt % based on the total weight of the finally obtained electrode material, and then was dried in a blast drying oven at 150° C. for 8 min to obtain a CDI electrode material. The electrode material was cut into 5×5 cm. The electrode material achieved 100% removal rate on mixed harmful ions including 0.3 mg/L of Ag(I), 0.3 mg/L of Cu(II), 0.3 mg/L of Pb(II), 0.3 mg/L of Se (IV, SeO₃²⁻) and 0.3 mg/L of Sb(III) under application of 1.2 V DC voltage for 20 min.

### Example 3

8 g of glucose and 3 g of titanium oxide nanoparticles were ultrasonically dissolved in 50 ml of deionized water for 30 min to obtain a graphene-based precursor solution. 40 parts of glass fiber cloth with a diameter of 3.5 μm and 10 parts of glass fiber cloth with a diameter of 1.5 μm were agitated and dispersed by a fiber dissociation device at 8000 r/min for 4 min to obtain a slurry with a concentration of 9 wt %. The slurry was wet formed by a paper machine to obtain a glass fiber sheet. The glass fiber sheet was cleaned in 50 ml of hydrochloric acid solution with a concentration of 6 mol/L for 60 min, and dried on a drying plate at a temperature of 100° C. for 6 min. The dried glass fiber sheet was put into the graphene-based precursor solution and was reacted in a microwave rapid reactor at 200° C. for 12 min, so as to in-situ synthesize a composite material of graphene and photocatalytic nano-material. The obtained material was then immersed in a binder system containing a polyurethane-modified phenolic resin in such a way that the amount of the binder system contained in the finally obtained electrode material is 9 wt % based on the total weight of the finally obtained electrode material, and then was dried in a blast drying oven at 200° C. for 10 min to obtain a CDI electrode materials. The electrode material was cut into 7×7 cm. The electrode material achieved 100% removal rate on mixed harmful ions including 0.4 mg/L of Ag(I), 0.4 mg/L of Cu(II), 0.4 mg/L of Pb(II), 0.4 mg/L of Se (IV, SeO₃²⁻) and 0.4 mg/L of Sb(III) under application of 1.2 V DC voltage for 20 min.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. An electrode material, comprising:
3 to 7 wt % of a graphene material;
4 to 8 wt % of a photocatalytic nano-material;
3 to 9 wt % of a binder system; and
a balance of a glass fiber cloth,
based on a total weight of the electrode material.

2. The electrode material according to claim 1, wherein the glass fiber cloth comprises: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth.

3. The electrode material according to claim 2, wherein the alkali metal oxide is at least one selected from Na₂O and K₂O.

4. The electrode material according to claim 1, wherein glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

5. The electrode material according to claim 1, comprising:
a main body of the glass fiber cloth;
a composite material layer of graphene and a photocatalytic nano-material grown in-situ on a surface of the glass fiber cloth; and
a nano-binder layer formed on the composite material layer.

6. The electrode material according to claim 1, wherein the glass fiber cloth has a three-dimensional porous network structure where glass fibers with different diameters are overlapped with each other.

7. The electrode material according to claim 1, wherein the binder system comprises one or more binders at different weight ratios.

8. The electrode material according to claim 1, wherein the binder system comprises at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.

9. The electrode material according to claim 1, wherein the photocatalytic nano-material comprises at least one photocatalytic renewable material selected from zinc oxide, titanium oxide and tungsten oxide.

10. The electrode material according to claim 1, wherein a composite material of graphene and the photocatalytic nano-material is closely and uniformly distributed on the glass fiber cloth.

11. A method for preparing an electrode material, comprising:
providing a graphene-based precursor solution with a concentration of 6 to 8 mg/L by dissolving a carbon source and a photocatalytic nano-material in water;
agitating and dispersing two or more glass fiber cloths with different diameters to obtain an uniform slurry;
wet forming the slurry to obtain a glass fiber sheet, and cleaning and drying the glass fiber sheet;
putting the glass fiber sheet into the graphene-based precursor solution for in-situ synthesis such that the carbon source is in-situ grown into a graphene-based material on glass fibers to obtain a glass fiber paper; and
immersing the glass fiber paper with a binder system and drying the glass fiber paper to obtain the electrode material.

12. The method according to claim 11, wherein the carbon source comprises at least one selected from glucose, a biomass and graphite oxide.

13. The method according to claim 11, wherein the photocatalytic nano-material comprises at least one selected from zinc oxide, titanium oxide and tungsten oxide.

14. The method according to claim 11, wherein the agitating and dispersing are performed at an agitating speed of 5000 to 12000 rpm, and the slurry has a concentration of 5 to 10 wt % and a pH value of 3.0 to 5.0.

15. The method according to claim 11, wherein the cleaning is performed in a hydrochloric acid solution with a concentration of 3 to 6 mol/L for 30 to 60 min.

16. The method according to claim 11, wherein the drying the glass fiber sheet comprises:
drying the glass fiber sheet on a drying plate at a temperature of 100 to 115° C. for 4 to 6 min.

17. The method according to claim 11, wherein the in-situ synthesis is performed by H₂ reduction, high temperature graphene oxide reduction, microwave heating or laser reduction.

18. The method according to claim 11, wherein the drying the glass fiber paper comprises:
drying the glass fiber paper at a temperature of 100 to 200° C. for 6 to 10 min.

19. The method according to claim 11, wherein the glass fiber cloth comprises: 56.5 to 65.5 wt % of SiO₂, 3 to 8 wt % of Al₂O₃, 4.5 to 8.5 wt % of MgO, 1.5 to 4.5 wt % of CaO, 3 to 6 wt % of B₂O₃, 4.5 to 5.5 wt % of a mixture of Fe₂O₃, ZnO and BaO, and 8 to 9.5 wt % of an alkali metal oxide R₂O, based on a total weight of the glass fiber cloth;
wherein the alkali metal oxide is at least one selected from Na₂O and K₂O;
wherein glass fibers of the glass fiber cloth have a fiber diameter normally distributed between 0.6 and 4 μm with an average fiber diameter of 2.2 μm, and a fiber length normally distributed between 15 and 30 mm with an average fiber length of 20 mm.

20. The method according to claim 11, wherein the binder system comprises at least one selected from a pure acrylic emulsion, a silicone acrylic emulsion, a styrene acrylic emulsion, an acetate acrylic emulsion, a urea-modified phenolic resin, a polyurethane-modified phenolic resin and a melamine-modified phenolic resin.
